(19) United States
(12) Patent Application Publication
(10) Pub. No.: US 2024/0296836 A1
(43) Pub. Date: Sep. 5, 2024

(54) METHOD AND APPARATUS FOR GENERATING DATA TO TRAIN MODELS FOR ENTITY RECOGNITION FROM CONVERSATIONS

(71) Applicant: Uniphore Technologies, Inc., Palo Alto, CA (US)

(72) Inventor: Gideon Hollander, Herzliya (IL)

(21) Appl. No.: 18/116,302

(22) Filed: Mar. 2, 2023

(51) Int. Cl. G10L 15/08; G10L 15/06

(52) U.S. Cl. CPC G10L 15/083; G10L 15/063; G10L 2015/0631; G10L 2015/0638

(57) ABSTRACT

In a method and apparatus for generating training data to train models for entity recognition from conversations, the method includes identifying a first text from a first data element on a first graphical user interface (GUI), on which a first action is performed by a first agent, the first data element corresponding to an entity type, wherein the first action comprises at least one of typing, clicking, highlighting, hovering or reading, matching the first text to a first transcribed text within a transcription of a first conversation between the first agent and a first customer, where the first transcribed text corresponds to a time proximate to the time the first action, and determining at least a portion of the first transcribed text as an automatically generated training data (AGTD) for the entity.

### FIELD

The present invention relates generally to customer service computing and management systems, such as those used in call centers, and particularly to generating data to train artificial intelligence and/or machine learning (AI/ML) models for entity recognition from conversations.

### BACKGROUND

Several businesses need to provide support to its customers, which is provided by a customer service center (also known as a “call center”) operated by or on behalf of the businesses. Customers of a business place an audio or a multimedia call to, or initiate a chat with, the call center of the business, where customer service agents address and resolve customer issues, to address the customer's queries, requests, issues and the like. The agent uses a computerized management system used for managing and processing interactions or conversations (e.g., calls, chats and the like) between the agent and the customer. The agent is expected to understand the customer's issues, provide appropriate resolution, and achieve customer satisfaction.

Customer service management systems (or call center management systems) may help with an agent's workload, complement or supplement an agent's functions, manage agent's performance, or manage customer satisfaction, and in general, such call management systems can benefit from understanding the content of a conversation, such as entities mentioned, intent of the customer, among other information. Such systems may rely on automated identification of intent and/or entities of the customer (e.g., in a call or a chat). Accuracy, efficiency and training time of models depend greatly on the accuracy of the training data, and generating accurate data sets for training models for entity recognition remains a challenge. Most models are currently trained on large volumes of training data because accurate data is not available, and training models with high volumes of training data is expensive, time consuming, and may still result in models lacking desired accuracy. Further, training models with such data typically requires input from data scientists, which is also expensive and potentially cumbersome.

Accordingly, there is a need in the art for method and apparatus for generating data to train models for entity recognition from conversations.

### SUMMARY

The present invention provides a method and an apparatus for generating data to train artificial intelligence and/or machine learning (AI/ML) models for entity recognition from conversations, substantially as shown in and/or described in connection with at least one of the figures, as set forth more completely in the claims. These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an apparatus for generating data to train models for entity recognition from conversations, in accordance with an embodiment of the present invention.

FIG. 2 illustrates a first screen of a graphical user interface (GUI) of an agent device of the apparatus of FIG. 1, in accordance with an embodiment of the present invention.

FIG. 3 illustrates a second screen from the GUI of FIG. 2, in accordance with an embodiment of the present invention.

FIG. 4 illustrates a screen of a GUI of a business analyst device of the apparatus of FIG. 1, in accordance with an embodiment of the present invention.

FIG. 5 illustrates a method for generating data to train models for entity recognition from conversations, in accordance with an embodiment of the present invention.

### DETAILED DESCRIPTION

Embodiments of the present invention relate to generating data to train artificial intelligence and/or machine learning (AI/ML) models for entity recognition from conversations, for example, conversations between a customer and an agent of a customer service center, or between two or more persons in other environments. Embodiments disclosed herein generate training data sets by clustering several conversations or calls, or transcribed text thereof, according to call intent. The intent used for clustering the calls is assigned by the agent working on the call in the call summary, or obtained by other means, for example, from a model trained to correlate agent's screen activity with call intent.

For a given intent cluster, the screen activity of agents working on a graphical user interface (GUI) screen during calls with customers, known as agent activity data, is also recorded. A data element in the GUI that the agent spends time on, for example, by typing, clicking or hovering a cursor, also referred to as agent activity, is identified. Metadata associated with the data element is used to designate the entity type associated with the data element. The conversation portion during, and optionally before and/or after, the time spent by the agent on the data element is identified as relevant to the entity type. The identified relevant conversation portions or transcribed text thereof from different calls, within the same intent cluster and/or from different intent clusters, is aggregated and referred to as automatically generated training data (AGTD) for the entity type. The AGTD is usable to train models for entity recognition from conversations. In some embodiments, AGTD is further validated by a person knowledgeable about the business, for example, by a business analyst, to further increase the relevancy and/or accuracy of the AGTD, and to generate validated training data (VTD) for training models for entity recognition from conversations.

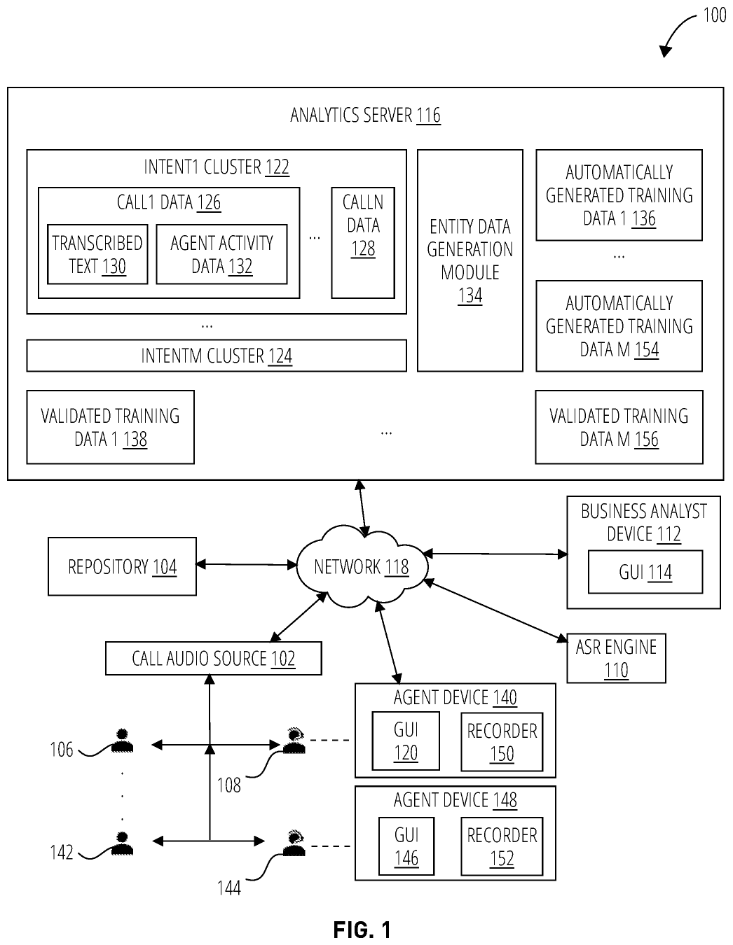

FIG. 1 illustrates an apparatus 100 for generating data to train models for entity recognition from conversations, in accordance with an embodiment of the present invention. The apparatus 100 includes a call audio source 102, for example a customer service center or call center, to which customers 106, 142 of a business call in for support or service, and agents 108, 144 working on behalf of the business, address the calls of the customers 106, 142, respectively. The apparatus 100 includes agent devices 140, 148 accessible to the agents 108, 144, respectively. The apparatus 100 further includes a repository 104, an automatic speech recognition (ASR) Engine 110, a business analyst device 112, an analytics server 116, and a network 118 communicably coupling components of the apparatus 100.

The call audio source 102 provides audio of a conversation, for example, a call between the customer 106 and the agent 108, or between the customer 142 and the agent 144, to the ASR Engine 110. In some embodiments, the audio is streamed to the ASR Engine 110 while a call is active, and in some embodiments, the audio is sent to the ASR Engine 110 after the call is concluded. The ASR Engine 110 transcribes the audio to text data, which is then sent to, and stored in, the repository 104. In some embodiments, the call audio source 102 sends the audio to the repository 104 for storage, and the stored audio may be transcribed at a later time, for example, by sending the audio from the repository 104 to the ASR Engine 110. The transcribed text may be sent from the ASR Engine 110 directly to the analytics server 116, or to the repository 104 for later retrieval by the analytics server 116.

In some embodiments, the agent 108 interacts with a graphical user interface (GUI) 120 of an agent device 140 for providing inputs and viewing outputs, before, during and after a call. The agent device 140 is a general computer, such as a personal computer, a laptop, a tablet, a smartphone, as known in the art, and includes the GUI 120, among other standard components, such as a camera, a microphone, among others as known in the art. In some embodiments, the GUI 120 is capable of displaying, to the agent 108, various workflows and forms configured to receive input information about the call, and receiving, from the agent 108, one or more inputs, for example, to change address of the customer 106, make a travel booking, among various other functions. Similar to the agent 108 interacting with the GUI 120 of the agent device 140, the agent 144 interacts with the GUI 146 of the agent device 148, which has similar capability and functionality as the agent device 140. The agent devices 140, 148 include recorders 150, 152, respectively, to record the activity of the agents 108, 144 on the respective GUIs 120, 146 during the call, respectively, as agent activity data, and send the agent activity data to the repository 104 for storage therein, and retrieval, for example, by the analytics server 116. In some embodiments, the agent activity data is sent directly from the agent devices 140, 148 to the analytics server 116. In this manner, transcribed text and agent activity data of several conversations is aggregated and made available for access to the analytics server 116. In some embodiments, the recorders 150, 152 include an eye tracking functionality to determine which areas of a display screen (GUI) the agent is looking at while the agent is performing an operation on the GUI. In some embodiments, the recorders 150, 152 include functionality to monitor GUI interactions of agent occurring on the agent device, such as the data entered into a field on a screen or GUI and the corresponding field label, cursor position, clicking information. The data points from eye tracking and from agent interactions with the GUI, clicking, highlighting, typing, hovering and the like are recorded as the agent activity data.

In some embodiments, the repository 104 stores recorded audios of conversations or calls between a customer and an agent, for example, the customer 106 and the agent 108, or the customer 142 and the agent 144, received from the call audio source 102. In some embodiments, the repository 104 stores transcribed text of the conversations, for example, received from the ASR Engine 110. In some embodiments, the repository 104 stores audios of some conversations, and transcribed text of some conversations, or both the audios and transcribed text of some conversations. The repository 104 also stores the agent activity data, such as activity of the agent 108 with respect to a graphical user interface (GUI) 120 of the agent device 140, for example, typing in, clicking on, hovering a cursor on or near, or eye movement to or eye focus (such as for reading) at a field on the GUI. Similarly, the repository 104 stores the conversation audio and/or transcribed text between the customer 142 and the agent 144, and the screen activity performed by the agent 144 on a GUI 146 of the agent device 148.

The ASR Engine 110 is any of the several commercially available or otherwise well-known ASR Engines, providing ASR as a service from a cloud-based server, a proprietary ASR Engine, or an ASR Engine which can be developed using known techniques. ASR Engines are capable of transcribing speech data (spoken words) to corresponding text data (transcribed text, text words or tokens) using automatic speech recognition (ASR) techniques, as generally known in the art, and include a timestamp for some or each token(s).

The business analyst device 112 is a general purpose computer, such as a personal computer, a laptop, a tablet, a smartphone, as known in the art, and includes a GUI 114. The GUI 114 of the business analyst device 112 is used by a person knowledgeable about the business, such as a business analyst, for example, to review and validate training data generated by the analytics server 116.

The analytics server 116 includes various clusters of call data, for example, intent1 cluster 122 . . . intentM cluster 124, an entity data generation module (EDGM) 134, automatically generated training data (AGTD) 136, and a validated training data (VTD) 138.

In some embodiments, the analytics server 116 is provided call data from several calls, which is organized in to clusters according to intent of the calls. Each cluster, for example, intent1 cluster 122, . . . intentM cluster 124 includes call data from several calls identified as having a common call intent. Intent for calls is obtained, for example, from a call summary prepared by agents handling calls, or may obtained from a software that determines an intent of the call based on agent's screen activity. For example, intent1 cluster 122 includes call data for calls 1-N identified by respective agents as having the intent of “change address.” The intent1 cluster 122 includes call1 data 126 . . . callN data 128 for each of the 1-N calls. Similarly, different clusters (for example, intentM cluster 124) may include call data corresponding to multiple calls having an intent different than the intent of intent1 cluster 122.

Each call data includes transcribed text for a call and agent activity data of the agent on the respective GUI for the call. For example, call1 data 126 includes a transcribed text 130 of the call between the customer 106 and the agent 108, and an agent activity data 132 of the agent 108 on the GUI 120. Similarly, callN data 128 includes a transcribed text of the call between a customer 142 and an agent 144, and an agent activity data of the agent 144 on the GUI 146. While two pairs of customers and agents, that is the customer 106 and the agent 108, and the customer 142 and the agent 144, are shown in FIG. 1, it is understood that different calls of a cluster may occur between several different customer(s) and/or agent(s).

Each of the transcribed text and the agent activity data includes chronological indicators, for example, timestamps, to indicate when a word in the transcribed text was spoken, and when an action was taken by the agent. In some embodiments, the transcribed text includes the words spoken in the call arranged in a sequential manner, and the timestamps to determine when one or more words were spoken. The agent activity data includes agent activity or actions with respect to a particular data element, and include any action that can be performed by agents on the agent device, for example, such as typing, clicking, highlighting, reading text in a field or a field label, selection of or clicking a particular data element, hovering of a cursor at, or proximate to, a data element for given time (for example, 100 ms), and the like. In some embodiments, the agent activity data also includes the call summary prepared by the agent, and/or the call intent assigned by the agent.

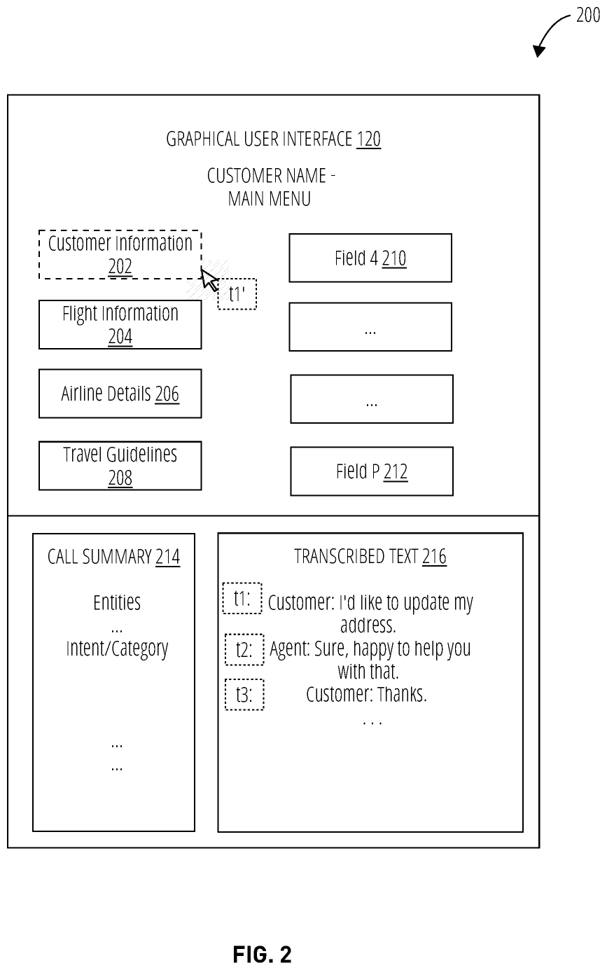

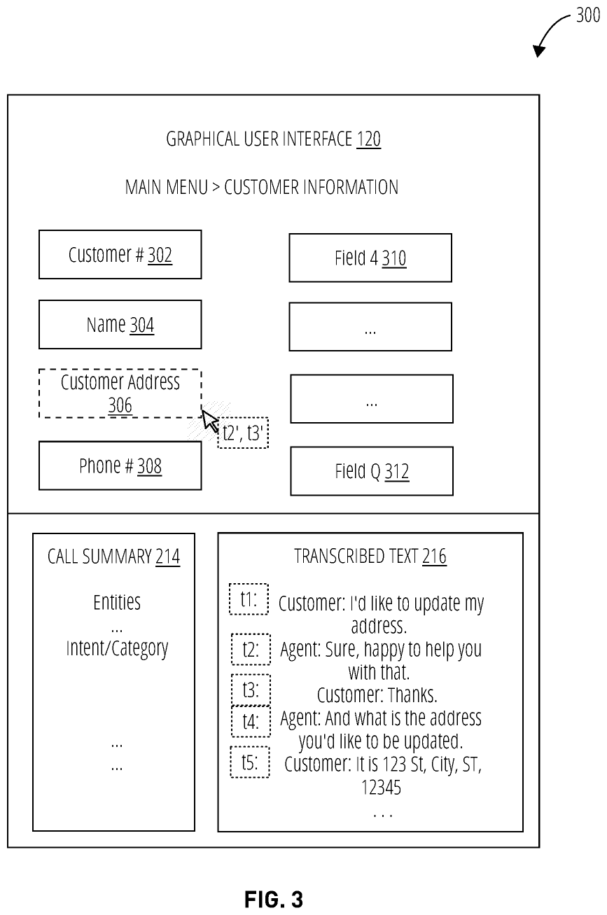

For example, FIG. 2 and FIG. 3 depict a first screen and a second screen displayed on the graphical user interface 120 (GUI 120) used by the agent 108 during a call with the customer 106. During the call, while in conversation with the agent 108, the customer 106 indicates that they would like to change their address at time instance t1, for example, by speaking “I'd like to update my address.” At this time, the agent 108 is on the main menu at the GUI 120 as shown in FIG. 2, and the main menu has several buttons, such as customer information 202, flight information 204, airline details 206, travel guidelines 208, field 4 210, . . . field p 212. Further, the GUI 120 shows the call summary 214 section, which may be automatically generated, typed in by the agent 108, or a combination thereof, and the transcribed text 216 section, showing the transcribed text of the conversation, generated using ASR techniques.

At time instance t1′, sometime after t1, the agent 108 clicks on the “customer information 202” button to get to the customer information menu in the GUI 120, as shown in FIG. 3. The customer information menu includes different fields, such as customer #302, name 304, customer address 306, Phone #308, field 4 310, . . . Field q 312. At time instance t2′, sometime after t1′, while the agent 108 is on the customer information menu, the agent 108 clicks on the customer address 306 field. The conversation between the customer 106 and the agent 108 progresses, for example, as seen from the transcribed text representing speech at instances t1-t5, and beyond. The customer 106 provides the address to be updated at t5. At time t3′, sometime after t2′ and t5, the agent 108 types the address provided by the customer 106 in the customer address 306 field, updating the address. The actions of the agent 108 on the GUI 120, and the time at which the actions occur are recorded, for example, by the recorder 150 as the agent activity data during the agent 108 conversation with the customer 106, and possibly some time before and/or after the conversation. According to some embodiments, the recorder 150 determines a label or name of the data element or the field, for example, the identification of the field customer address 306, as the entity type associated with the data element. In the example of FIG. 3, the customer address 306 data element has “customer address” as the identification thereof, which is extracted as the entity type associated with the data element 306 by the recorder 150. In some embodiments, the entity type associated with the data element is determined using other methods as known in the art, such as automatically by analyzing the conversation during the agent activity associated with the data element, or as typed in by the agent 108 in the call summary 214, and the like. Further, the recorder 150 determines metadata or the data type associated with the data element or the entity type, such as whether the entity type is a currency, a date, a number, and the like. In some embodiments, the recorder 150 further determines as metadata specific types number, date or currency, for example, deductible, premium, incident date, coverage start date, a customer number, a claim number, and the like.

In some embodiments, during the call or sometime after, the agent 108 may update the call summary 214 to assign an intent to the call, for example, as “change of address.” In some embodiments, intent for the call is automatically populated based on the agent's screen activity (for example, clicking on customer address 306 field). At the conclusion of the call or a short time thereafter, the call summary 214 including the intent of the call, and the transcribed text 216 capturing the conversation are recorded. Eventually, the call data including the intent (from the call summary 214), the transcribed text 216 and the agent activity data are sent for storage in the repository 104, for later/offline availability for the analytics server 116.

The EDGM 134 is configured to generate training data automatically from one or more intent clusters of calls. The EDGM 134 first identifies, using the agent activity data of calls within a cluster, multiple calls having a similar agent activity, that is, the calls in which agent activity (actions on screen) is associated with a data element associated with a particular entity type.

The EDGM 134 then identifies from the transcribed text of each of the calls having the similar agent activity, a portion of the transcribed text of the calls associated with the similar agent activity. In some embodiments, the portion of the transcribed text overlapping with the duration of the agent activity for a data element, that is, between the time the agent started interacting with the data element (first action), and till the time the agent moved on to a different data element (second action), is considered as being associated with the agent activity. In some embodiments, each of the first action and the second action include one or more of typing, clicking, highlighting or reading, among other possible interactions as known in the art. In some embodiments, the portion of the transcribed text corresponding to conversation starting a predefined period of time earlier (for example, about 5 seconds) than the start of the agent activity, or starting a predefined number of turns earlier (for example, 1 or 2 turns) of the speaker(s) (agent or customer) before the start of the agent activity, is also considered to be associated with the sequence. In some embodiments, the portion of the transcribed text corresponding to conversation ending after a predefined period of time after (for example, about 2 seconds) the agent activity, or ending a predefined number of turns after (for example, 1 or 2 turns) of the speaker(s) (agent or customer) after the agent activity, is also considered to be associated with the sequence. The conversation between such sequence of actions, and possibly before and/or after such sequence is relevant to the entity associated with the data element.

Such portions of the conversation, that is, the transcribed text from different calls within the cluster of calls with the same intent, are identified by the EDGM 134 as being relevant to the entities mentioned in the calls of the cluster. Such portions of the transcribed text and the entities input by the agent in the data elements are combined automatically by the EDGM 134, and are referred to as automatically generated training data 136 or AGTD 136 for the entity type. The AGTDs (for example, AGTDs 136, 154) are highly accurate data pertinent to the entity type, and/or the entities mentioned in the calls of the intent cluster. Such data is usable for training AI/ML models for entity recognition from conversations, based on an input of transcribed text of calls. Different AGTDs are generated for different entity types, in the manner described above.

In some embodiments, AGTD for an entity type obtained from one intent cluster of calls is combined with AGTD for the same entity type obtained from another intent cluster of calls to generate aggregated AGTD for the same entity. For example, AGTD 136 for entity type “customer address” may be combined with AGTD 154 for entity type “customer address” to yield an aggregated AGTD for the entity “customer address.” For simplicity, reference to AGTD, and examples thereof, includes aggregated AGTD hereinafter, unless apparent otherwise from context.

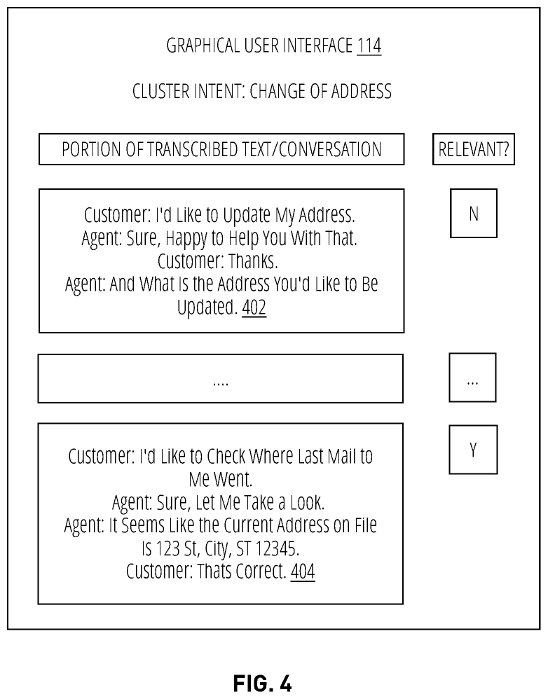

In some embodiments, the EDGM 134 is configured to further validate the AGTDs, for example, the AGTD 136 or aggregated AGTDs, or portions thereof, using a secondary input, such as a human input. For example, each of the portions of the transcribed text and/or the entity typed in the data element by the agent from the AGTD 136 is sent by the EDGM 134 to the business analyst device 112, for review by a business analyst, who affirms or negates the AGTD 136 or a portion thereof as being relevant to the entities mentioned in the calls of the cluster. In some embodiments, for example, as seen in FIG. 4, the business analyst uses the GUI 114 on the business analyst device 112 to display and validate the portions of transcribed conversation, AGTD 136 or portions thereof. The portion(s) of the transcribed text/conversation of the AGTD 136 negated by the business analyst, that are indicated as being not relevant to the entities mentioned in the calls of the cluster (for example, a NO or N indicated on portion 402), are removed from the AGTD 136, while other portions of the transcribed text that are either affirmed (for example, a Yes or Y indicated on portion 404) by the business analyst as being relevant, or are not negated by the business analyst, are assumed to be relevant to the entities mentioned in the calls of the cluster, and are preserved. The preserved portions of the transcribed text is assimilated as validated data VTD 138. In some embodiments, the EDGM 134 sends the various portions of the transcribed text of the AGTD 136 for being reviewed, for example, to the GUI 114 of the business analyst device 112, and receives the input from the business analyst device 112, for example, as entered by the business analyst, on whether a portion of the transcribed text of the AGTD 136 is relevant to the entities or not. The EDGM 134 removes the portions of the transcribed text indicated as not being relevant by the business analyst from the AGTD 136 to generate the VTD 138. Different VTDs are generated for different entity types. The VTDs (for example, VTD 138) are highly accurate data pertinent to the entities of the cluster, and are usable for training AI/ML models for entity recognition from a call, for example, based on an input of transcribed text of calls.

AGTDs and optionally VTDs are generated for each intent cluster, for example, AGTD 136 and VTD 138 for intent1 cluster 122, and AGTD 154 and VTD 156 for intentM cluster 124, and in some embodiments, aggregated for an entity across intent clusters according to entity types, for example, as discussed above. Models for entity recognition can be trained using the AGTDs or the VTDs quicker than models that are trained on entire transcribed text of the calls, and/or are more accurate than models trained using currently known techniques.

The network 118 is a communication network, such as any of the several communication networks known in the art, and for example a packet data switching network such as the Internet, a proprietary network, a wireless GSM network, among others. The network 118 is capable of communicating data to and from various connected apparatus 100 components, for example, the call audio source 102, the repository 104, the agent device 200, the ASR Engine 110, the business analyst device 112, and the Analytics server 116. In some embodiments, one or more apparatus 100 components are communicably coupled via a direct communication link (not shown), and may or may not be communicably coupled via the network 118. For example, the agent devices 140, 148 may send the agent activity data to the repository 104 either directly via the network 118, via the infrastructure of the call audio source 102 through the network 118, or via a direct link to the repository 104.

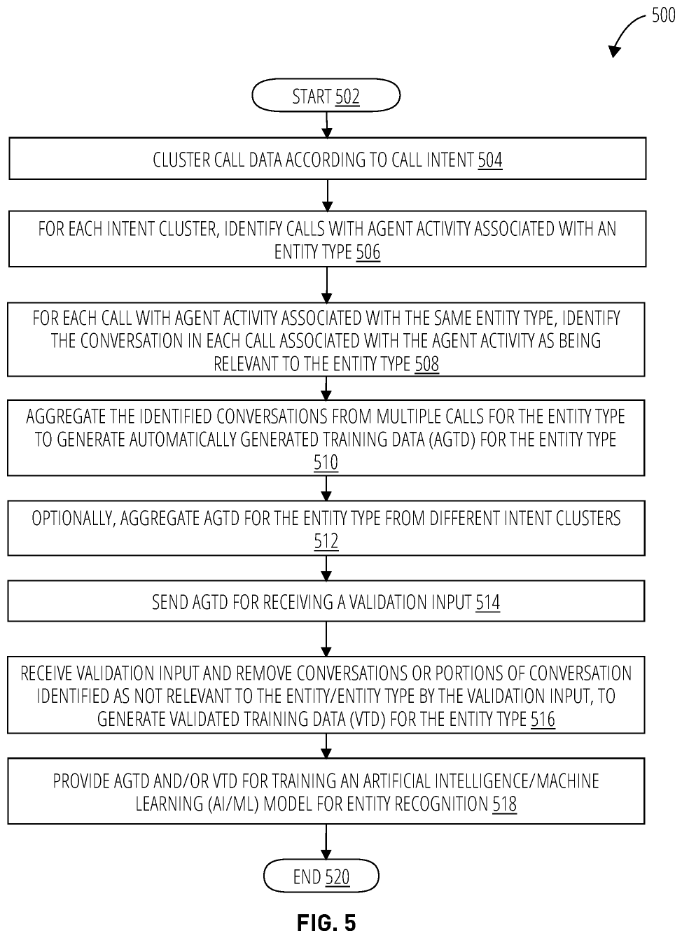

FIG. 5 illustrates a method 500 for generating data to train models for entity recognition from conversations, for example, performed by the EDGM 134 of the apparatus 100 of FIG. 1, in accordance with an embodiment of the present invention.

Call data including the transcribed text, the agent activity data and the intent for several calls is made available at the analytics server 116 to the method 500, for example, from the repository 104, or using other techniques described herein with respect to FIGS. 1-4 above, or as known in the art.

The method 500 starts at step 502, and proceeds to step 504, at which the method 500 clusters call data according to call intent. For example, the method 500 organizes all call data having a particular intent, intent1, for example, change of address, as a single cluster intent1 cluster 122, and all call data having a particular intent, intentM as a single cluster, for example, intentM cluster 124, as shown in FIG. 1.

At step 506, the method 500 identifies from each cluster, for example, from intent1 cluster 122, calls having a similar agent activity, for example, activity associated with a particular entity type data element in the GUI 120 that the agent 108 spends time on, for example, by typing, clicking or hovering a cursor proximate to the data element, is identified. The method 500 analyzes the agent activity data for each call in the intent1 cluster 122, and identifies call1 data 126 and callN data 128 as having a similar agent activity, that is, agent activity associated with data elements for the same entity type, the data elements presented on respective GUIs for respective agents. For example, the method 500 detects that call1 agent activity data 132 includes agent activity associated with a particular entity type data element, and callN agent activity data (not shown) includes an agent activity associated with the same entity type data element, even though the specific actions in the agent activity may not be the exact same and/or performed in the same exact order. Even though the specific actions are different and/or in different order, the agent activity associated with the entity type of data element of call1 and the agent activity associated with the same entity type of data element of callN are deemed same or similar because both are associated with the same entity type. As also discussed above, in some embodiments, certain portions of the conversation and screen activity may be ignored for evaluating similar sequences.

As an illustration, in call1 between the customer 106 and the agent 108, the first action of the agent activity is, for example, the action of selecting the customer address 306 field, performed by the agent 108 at t2′ as shown in FIG. 3, after time t1 and before time t4. The second action is, for example, the action of typing in the customer address 306 field or data element, which is performed by the agent 108 at t3′ as shown in FIG. 3, some time after t5. Similarly, callN is held between the customer 142 and the agent 144, who may select an address field on the respective GUI 146 as a first action, followed by hovering the cursor over a call summary section in the GUI 146 as an intervening action, followed by typing in the address field on the GUI 146 as a second action. In both examples, the agent activity is associated with the same entity type data element, that is, the data element for the customer address.

At step 508, for calls within a cluster and containing agent activity associated with the same data element, for example, call1 and callN as identified at step 506, the method 500 identifies the conversation in each of the calls overlapping with the agent activity as being relevant to an entity, for example, the entity associated with the data element or determined from the conversation that occurs during or proximate to the agent activity associated with the data element. For example, the method 500 identifies conversation of call1 between the first action at t2′ and the second action at t3′ or the time at which the agent completes typing in the customer address 306 data element as a first conversation portion, as being relevant to the first agent activity associated with the data element customer address 306 of FIG. 3. Similarly, the method 500 identifies the conversation of callN during the second agent activity associated with the same data element “customer address” (not shown in the drawings) as a second conversation portion, relevant to the second agent activity. In some embodiments, the method 500 includes, in the first conversation portion or the second conversation portion identified as relevant to the entity, additional conversation from before or after the first agent activity or before or after the second agent activity, for example, by a predefined duration of time (for example, 2 s or 5 s), or a predefined number of turns (for example, 2 or 3 turns) of the conversation.

At step 510, the method 500 aggregates or combines the identified conversations at step 508 from multiple calls, for example, from call1 and callN, to generate training data, referred to as automatically generated training data (AGTD) for recognition of the entity type associated with the data element, for intent1 call cluster. Similarly AGTD for entity recognition from other call clusters may be obtained using steps 504-510. In some embodiments, at step 512 the method 500 combines AGTD for an entity type obtained from a cluster of calls having an intent with AGTD for the same entity type obtained from another cluster of calls having a different intent to generate an aggregated AGTD for the same entity type. For example, AGTD 136 for entity “customer address” may be combined with AGTD 154 for entity “customer address” to yield an aggregated AGTD for the entity “customer address.” For simplicity, reference to AGTD, and examples thereof, includes aggregated AGTD hereinafter, unless apparent otherwise from context. In some embodiments, steps 508 and 510 are performed on calls from different intent clusters but pertaining to the same entity type, and in such embodiments, step 512 is not needed.

In some embodiments, at step 514, the method 500 sends the AGTD for receiving a validation input on the AGTD. For example, the AGTD is sent to the business analyst device 112, for display on the GUI 114, as discussed with respect to FIG. 4, for receiving a validation input from a business analyst on AGTD or portions thereof.

At step 516, the method 500 receives a validation input, for example, from the business analyst device 112, as provided by the business analyst via the GUI 114 thereon. The portions of AGTD may be identified as being relevant, not relevant, or no response may be received on some portions. Still at step 516, the method 500 removes at least those portions of conversation from the AGTD that are identified as not relevant to the call intent, to generate validated training data (VTD). The AGTD contains conversations relevant to the entity type, with a high degree of accuracy, and the VTD contains conversations relevant to the entity type with at least as much accuracy as the AGTD, or higher.

At step 518, the method 500 provides the AGTD or the VTD for training an artificial intelligence/machine learning (AI/ML) model for entity recognition, for example, for the entity type associated with the data element. The method 500 may send the AGTD or the VTD to a computing device on which the model for entity recognition based on conversations is implemented, or publish the AGTD of the VTD at a location from where the AGTD or the VTD may be accessed by parties wanting to train a model for entity recognition based on conversations.

The method 500 proceeds to step 520, at which the method 500 ends.

In this manner, the embodiments disclosed herein enable generating high quality training data for training models for entity recognition from conversations, without requiring a data science expert to validate the training data. The models can thus be trained faster, are more accurate and/or have higher computational efficiency. Such models can be used for entity recognition while the calls are active or live, in real time or as soon as possible within the physical constraints of the apparatus, with introduced delays, or offline. Further, for different intents, same entity type may be used, and each entity is referred to as a slot. The techniques used above are usable to train models to distinguish the slots.

While various techniques discussed herein refer to conversations in a call center environment, the techniques described herein are not limited to call center applications. Instead, application of such techniques is contemplated to any audio and/or text that may utilize the disclosed techniques, including single party (monologue) or a multi-party speech. While some specific embodiments have been described, combinations thereof, unless explicitly excluded, are contemplated herein.

In the above discussion, it is understood that in some case, the same agent may converse with different customers over different calls for the same call intent, and with the same customer over different calls with the same call intent, and similarly, the same customer may converse with different agents over different calls with the same call intent, and each of such different calls may be aggregated in the same intent cluster.

Various computing devices described herein, such as computers, for example, the agent devices 140, 148, the business analyst device 112, the analytics server 116, among others, include a CPU communicatively coupled to support circuits and a memory. The CPU may be any commercially available processor, microprocessor, microcontroller, and the like. The support circuits comprise well-known circuits that provide functionality to the CPU, such as, a user interface, clock circuits, network communications, cache, power supplies, I/O circuits, and the like. The memory is any form of storage used for storing data and computer readable instructions, which are executable by the CPU. Such memory includes, but is not limited to, random access memory, read only memory, disk storage, optical storage, various non-transitory storages known in the art, and the like. The memory includes computer readable instructions corresponding to an operating system, other computer readable instructions capable of performing described functions, and data needed as input for the computer readable instructions, or generated as output by the computer readable instructions.

The methods described herein may be implemented in software, hardware, or a combination thereof, in different embodiments. In addition, the order of steps in methods can be changed, and various elements may be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” and the like, indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. Embodiments can also be implemented as instructions stored using one or more machine-readable media, which may be read and executed by one or more processors. A machine-readable medium can include any mechanism for storing or transmitting information in a form readable by a machine (e.g., a computing platform or a “virtual machine” running on one or more computing platforms). For example, a machine-readable medium can include any suitable form of volatile or non-volatile memory.

In addition, the various operations, processes, and methods disclosed herein can be embodied in a machine-readable medium and/or a machine accessible medium/storage device compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium/storage device.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

This disclosure is to be considered as exemplary and not restrictive in character, and all changes and modifications that come within the guidelines of the disclosure are desired to be protected. Other technical features may be readily apparent to one skilled in the art from the following figures, descriptions, and claims.

I/We claim:

1. A computer implemented method for generating training data to train models for entity recognition from conversations, the method comprising:
identifying a first text from a first data element on a first graphical user interface (GUI), on which a first action is performed by a first agent, the first data element corresponding to an entity type, wherein the first action comprises at least one of typing, clicking, highlighting, hovering or reading;
matching the first text to a first transcribed text within a transcription of a first conversation between the first agent and a first customer, wherein the first transcribed text corresponds to a time proximate to the time the first action; and
determining at least a portion of the first transcribed text as an automatically generated training data (AGTD) for the entity.

2. The computer implemented method of claim 1, wherein the first action is performed by the agent while speaking to a customer.

3. The computer implemented method of claim 1, wherein the portion of the transcribed text corresponds to a conversation during the time of the first action, or before the first action, or both.

4. The computer implemented method of claim 3, wherein the conversation before the first action includes a predefined number of speaker turns, or a predefined duration of time, or both.

5. The computer implemented method of claim 4, wherein the predefined duration is about 5 seconds and wherein the predefined number of turns is 2.

6. The computer implemented method of claim 1, further comprising
identifying a second text from a second data element on a second graphical user interface (GUI), on which a second action is performed by a second agent, the second data element corresponding to the entity type, wherein the second action comprises at least one of typing, clicking, highlighting, hovering or reading;
matching the second text to a second transcribed text within a transcription of a second conversation between the second agent and a second customer, wherein the second transcribed text corresponds to a time proximate to the time the second action; and
including at least a portion of the second transcribed text in the AGTD for the entity.

7. The computer implemented method of claim 1, further comprising training a model for recognizing the entity using the AGTD.

8. The computer implemented method of claim 1, further comprising:
sending the AGTD and the entity for a validation input indicating either that a portion of the AGTD is relevant to the entity, or not relevant to the entity;
receiving the validation input; and
generating validated training data (VTD) from the AGTD by at least one of
removing the evaluated portion from the AGTD if the evaluated portion is indicated as not relevant, or
preserving the evaluated portion in the AGTD if the evaluated portion is indicated as relevant.

9. The computer implemented method of claim 8, further comprising training a model for recognizing the entity using the VTD.

10. The computer implemented method of claim 1, wherein at least one of the first agent, the first customer, the first graphical user interface or the first agent activity is the same as the second agent, the second customer, the second graphical user interface or the second agent activity, respectively.

11. A computing apparatus comprising:
a processor; and
a memory storing instructions that, when executed by the processor, configure the apparatus to:
identify a first text from a first data element on a first graphical user interface (GUI), on which a first action is performed by a first agent, the first data element corresponding to an entity type, wherein the first action comprises at least one of typing, clicking, highlighting, hovering or reading,
match the first text to a first transcribed text within a transcription of a first conversation between the first agent and a first customer, wherein the first transcribed text corresponds to a time proximate to the time the first action, and
determine at least a portion of the first transcribed text as an automatically generated training data (AGTD) for the entity.

12. The computing apparatus of claim 11, wherein the first action is performed by the agent while speaking to a customer.

13. The computing apparatus of claim 11, wherein the portion of the transcribed text corresponds to a conversation during the time the text of the first action, or before the first action, or both.

14. The computing apparatus of claim 13, wherein the conversation before the first action includes a predefined number of speaker turns, or a predefined duration of time, or both.

15. The computing apparatus of claim 14, wherein the predefined duration is about 5 seconds and wherein the predefined number of turns is 2.

16. The computing apparatus of claim 11, wherein the instructions further configure the apparatus to
identifying a second text from a second data element on a second graphical user interface (GUI), on which a second action is performed by a second agent, the second data element corresponding to the entity type, wherein the second action comprises at least one of typing, clicking, highlighting, hovering or reading,
match the second text to a second transcribed text within a transcription of a second conversation between the second agent and a second customer, wherein the second transcribed text corresponds to a time proximate to the time the second action, and
include at least a portion of the second transcribed text in the AGTD for the entity.

17. The computing apparatus of claim 11, wherein the instructions further configure the apparatus to train a model for recognizing the entity using the AGTD.

18. The computing apparatus of claim 11, wherein the instructions further configure the apparatus to:
send the AGTD and the entity for a validation input indicating either that a portion of the AGTD is relevant to the entity, or not relevant to the entity;
receive the validation input; and
generate validated training data (VTD) from the AGTD by at least one of
remove the evaluated portion from the AGTD if the evaluated portion is indicated as not relevant, or
preserve the evaluated portion in the AGTD if the evaluated portion is indicated as relevant.

19. The computing apparatus of claim 18, wherein the instructions further configure the apparatus to train a model for recognizing the entity using the VTD.

20. The computing apparatus of claim 11, wherein at least one of the first agent, the first customer, the first graphical user interface or the first agent activity is the same as the second agent, the second customer, the second graphical user interface or the second agent activity, respectively.
